(19) United States
(12) Patent Application Publication
(10) Pub. No.: US 2009/0308411 A1
(43) Pub. Date: Dec. 17, 2009

(54) STRING AND INSTRUMENT CLEANING SYSTEM

(76) Inventor: David Chiappetta, Brooklyn, NY (US)

Correspondence Address: BUCKLEY, MASCHOFF & TALWALKAR LLC, 50 LOCUST AVENUE, NEW CANAAN, CT, 06840, US

(21) Appl. No.: 12/487,368

(22) Filed: Jun. 18, 2009

Related U.S. Application Data
(63) Continuation-in-part of application No. 12/129,169, filed on May 29, 2008.
(60) Provisional application No. 61/073,451, filed on Jun. 18, 2008.

(51) Int. Cl. B08B 7/00; A47L 25/00

(52) U.S. Cl. 134/6; 15/209.1

(57) ABSTRACT

An apparatus may include a first support, a first cleaning material coupled to a first side of the first support, a second support coupled to the first support at a first edge of the second support, a second cleaning material coupled to a first side of the second support, and a third cleaning material coupled to a second side of the second support.

Some aspects include placement of a second support between a musical instrument and a string coupled to the musical instrument, and rotation of a first support coupled to a first edge of the second support with respect to the second support to dispose the string between the first support and the second support, to bring a first cleaning material coupled to a first side of the first support in contact with the string, to bring a second cleaning material coupled to a first side of the second support in contact with the string, and to bring a third cleaning material coupled to a second side of the second support in contact with the musical instrument.

### CROSS-REFERENCE TO RELATED APPLICATIONS

This application is a Continuation-in-Part of U.S. patent application Ser. No. 12/129,169, filed May 29, 2008 and entitled “String Cleaning System”, and claims priority to U.S. Provisional Patent Application Ser. No. 61/073,451, filed Jun. 18, 2008 and entitled “String Cleaning System”, the contents of both of which are incorporated by reference herein for all purposes.

### BACKGROUND

1. Field

The present specification relates generally to string and instrument cleaning systems.

2. Description of Related Art

Many types of musical instruments use strings to generate sound. Musical instrument strings may consist of nylon, steel, intestinal material (i.e., “gut”), or any other suitable materials. A string may collect debris on its surface and in its microscopic pores, which reduces the quality of sound generated thereby and may increase the possibility of breakage. This debris may consist, for example, of dust from the surrounding air or oil, dirt and sweat from a musician's fingers. Steel strings may also collect rust simply due to their exposure to air. “Wound” strings, which consist of one or more strings wrapped around a core of one or more other strings, are particularly susceptible to collecting debris. Wound strings are also more difficult to clean than unwound strings.

Several string cleaning techniques are known. One such technique, exemplified by U.S. Pat. No. 4,112,808, involves removing a wound string from an instrument, wrapping the string around one or more rollers, and moving the string back and forth along the rollers to dislodge dirt within the string. Other techniques do not require removal of the string from the instrument. Such techniques include devices for surrounding one or more strings with a cloth (e.g., U.S. Pat. No. 4,528,889) or with cleaning pads (e.g., German Publication DE 3003402A1) and moving the cloth or pads relative to the strings.

All conventional string cleaning techniques pose one or more problems. Some are extremely inefficient and time-consuming, such as that described in U.S. Pat. No. 4,112,808. The devices mentioned above may provide insufficient pressure on the strings, present difficulties in placing the cloth or pad between the strings and the instrument, may damage portions of the instrument with which they come into contact, fail to securely maintain the cloth or pad around the strings, and/or include elements that skew or twist during use. What is needed is a system to address one or more of the foregoing shortcomings.

### SUMMARY

Some embodiments may address the foregoing by providing an apparatus including a first support, a first cleaning material coupled to a first side of the first support, and a second support coupled to the first support at a first edge of the second support. The apparatus may also include a second cleaning material coupled to a first side of the second support, and a third cleaning material coupled to a second side of the second support.

In some aspects, the second cleaning material is integral with the third cleaning material.

According to some aspects, a second support is placed between a musical instrument and a string coupled to the musical instrument. A first support coupled to a first edge of the second support is rotated with respect to the second support to dispose the string between the first support and the second support, to bring a first cleaning material coupled to a first side of the first support in contact with the string, to bring a second cleaning material coupled to a first side of the second support in contact with the string, and to bring a third cleaning material coupled to a second side of the second support in contact with the musical instrument.

The claims are not limited to the disclosed embodiments, however, as those in the art can readily adapt the teachings herein to create other embodiments and applications.

### BRIEF DESCRIPTION OF THE DRAWINGS

Embodiments will become readily apparent from consideration of the following specification as illustrated in the accompanying drawings, in which like reference numerals designate like parts, and wherein:

FIG. 1 is a top perspective view of a cleaning apparatus according to some embodiments;

FIG. 2 is a top perspective view of a cleaning apparatus according to some embodiments;

FIG. 3 is a bottom perspective view of a cleaning apparatus according to some embodiments;

FIG. 4 is a close-up perspective view of a latch according to some embodiments;

FIG. 5 is a side elevational view of a cleaning apparatus during use according to some embodiments;

FIG. 6 is a side elevational view of a cleaning apparatus during use according to some embodiments;

FIG. 7 is a side elevational view of a cleaning apparatus during use according to some embodiments;

FIG. 8 is a top perspective view of a cleaning apparatus during use according to some embodiments;

FIG. 9 is a close-up cross-sectional view of a latch engaged with an opening according to some embodiments;

FIG. 10 is a close-up side elevational view of a portion of a cleaning apparatus during use according to some embodiments;

FIG. 11 is a side perspective view of a cleaning apparatus according to some embodiments;

FIG. 12 is a side perspective view of a cleaning apparatus according to some embodiments; and

FIG. 13 is a side perspective view of a cleaning apparatus according to some embodiments.

### DETAILED DESCRIPTION

The following description is provided to enable any person in the art to make and use the described embodiments and sets forth the best mode contemplated by the inventor for carrying out the described embodiments. Various modifications, however, will remain readily apparent to those in the art.

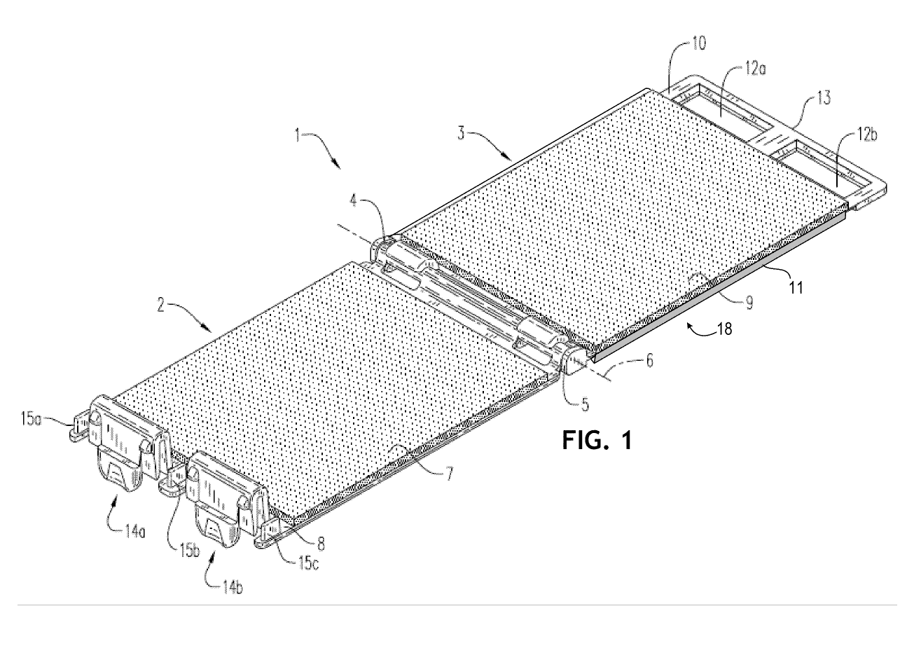

FIG. 1 is a perspective view of apparatus 1 according to some embodiments. Apparatus 1 may comprise an apparatus to clean one or more instrument strings, including but not limited to guitar strings, bass guitar strings, banjo strings, and mandolin strings. Apparatus 1 may also or alternatively be used to clean piano strings, harp strings, violin strings, cello strings, or any other suitable string of any composition that is or becomes known. In addition to string cleaning, apparatus 1 may be employed to clean parts of an instrument, such as frets, a fretboard or a fingerboard, which are disposed adjacent to the one or more strings being cleaned. The verb “clean” as used herein does not necessarily denote removal of all foreign substances from an object, but encompasses actions that attempt to remove some amount of debris.

Apparatus 1 includes first support 2 and second support 3, which are rotatably coupled to one another. That is, in the illustrated example, edge 4 of first support 2 and edge 5 of second support 3 include features for coupling first support 2 to second support 3 and enabling at least partial rotation about axis 6. Any suitable features may be employed for these functions in some embodiments, including but not limited to an integral (i.e., “living”) hinge. Accordingly, in some embodiments, first support 2 and second support 3 are integral with one another.

First cleaning material 7 is coupled to first side 8 of first support 2, second cleaning material 9 is coupled to first side 10 of second support 3, and third cleaning material 11 is coupled to second side 18 of second support 3. Cleaning materials 7, 9 and 11 may be coupled to their respective support using any suitable adhesive (e.g., glue) or fastener (e.g., thread stitches). First cleaning material 7, second cleaning material 9 and third cleaning material 11 may be composed of different or substantially identical materials. Any currently- or hereafter-known material may be used for first cleaning material 7, second cleaning material 9 and third cleaning material 11. The compositions of first cleaning material 7 and second cleaning material 9 may be particularly suited to cleaning particular types of string material, while the composition of third cleaning material 11 may be particularly suited to cleaning particular types of fretboards/fingerboards, such as finished ebony, rosewood, maple, etc. For example, first cleaning material 7 and second cleaning material 9 may be suited for cleaning steel.

In some embodiments, first cleaning material 7, second cleaning material 9 and third cleaning material 11 comprise microfiber material. Microfiber material may comprise fibers of 0.9 denier or finer. Some microfiber material utilizes polyester fibers for scrubbing properties and polymide fibers for absorbing and drying properties. The fibers are woven into a fabric that may include thousands of loops per square inch. The loops may dislodge small particles from small crevices and trap the particles within the weave. The loops may hold and distribute a cleaning solution in some embodiments. In some embodiments, second cleaning material 9 is between 0.075 in. and 0.125 in. thick. Such a thickness may facilitate passage of material 9 and second support 3 between a string and an instrument while still providing sufficient height for the loops of material 9 to contact sides of the string.

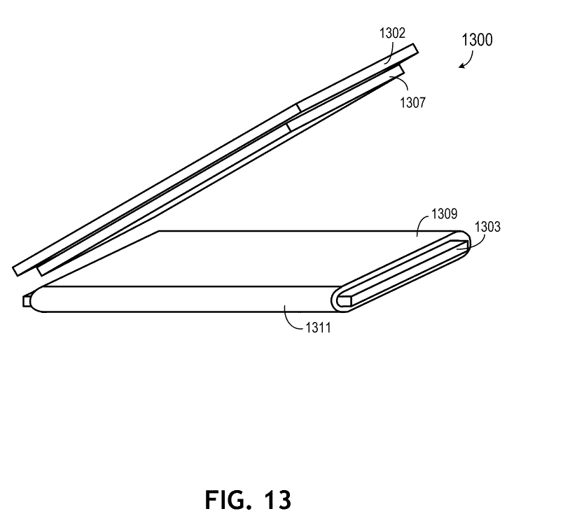

Second cleaning material 9 and third cleaning material 11 of apparatus 1 are integral with one another, but embodiments are not limited thereto. In the illustrated embodiment, second cleaning material 9 and third cleaning material 11 comprise a single continuous piece of material, with a portion of the piece of material wrapping around and over an edge of second support 3 as illustrated. In some embodiments, the single continuous piece of material wraps all the way around second support 3 so that a first end of the single continuous piece of material touches a second end of the single continuous piece of material as illustrated in FIG. 13.

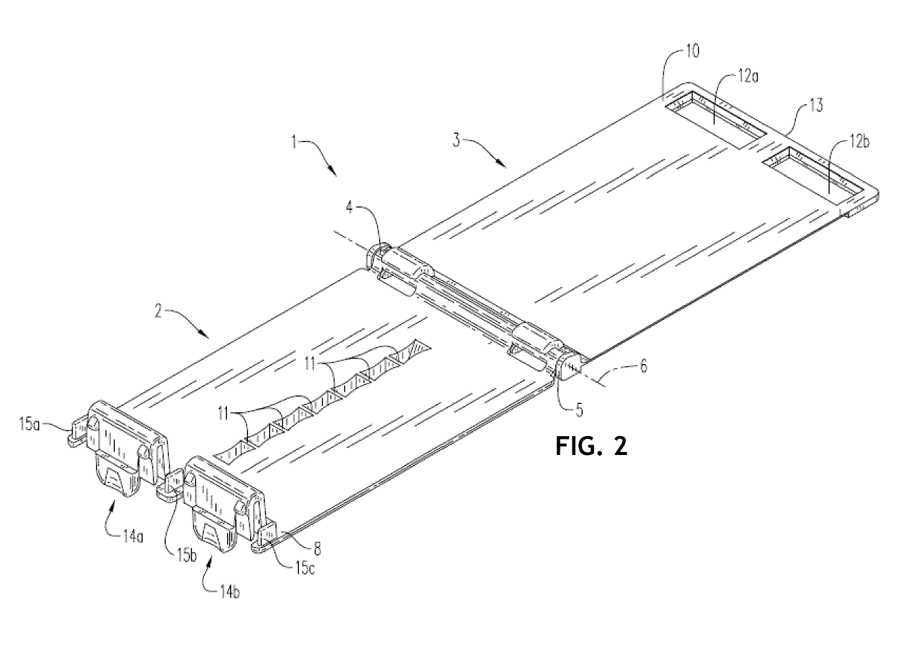

FIG. 2 is a top perspective view of apparatus 1 without first cleaning material 7, second cleaning material 9 or third cleaning material 11. FIG. 2 shows first side 8 to which first cleaning material 7 will be coupled and first side 10 to which first cleaning material 9 will be coupled. Also shown are anti-skew ribs 11 defined by second support 3. Anti-skew ribs 11 may reduce a tendency of second support 3 and/or a handle coupled thereto to skew during use as will be described below. Some embodiments do not include anti-skew ribs 11.

FIGS. 1 and 2 also show openings 12a and 12b defined by second support 3. Openings 12a and 12b are shown adjacent to edge 13 of support 3. Latches 14a and 14b may engage openings 12a and 12b according to some embodiments as will also be described below. Generally, engagement of openings 12a and 12b by latches 14a and 14b may maintain first side 8 of support 2 in a substantially fixed relationship with first side 10 of second support 3. Moreover, in some embodiments, the relationship is securely maintained during use.

Stops 15a through 15c are coupled to first side 8 of support 2. Stops 15a through 15c may engage (i.e., touch) first side 10 of second support 3 when latches 14a and 14b engage openings 12a and 12b. Stops 15a through 15c may thereby assist in maintaining a minimum spacing between first side 8 and first side 10 during use.

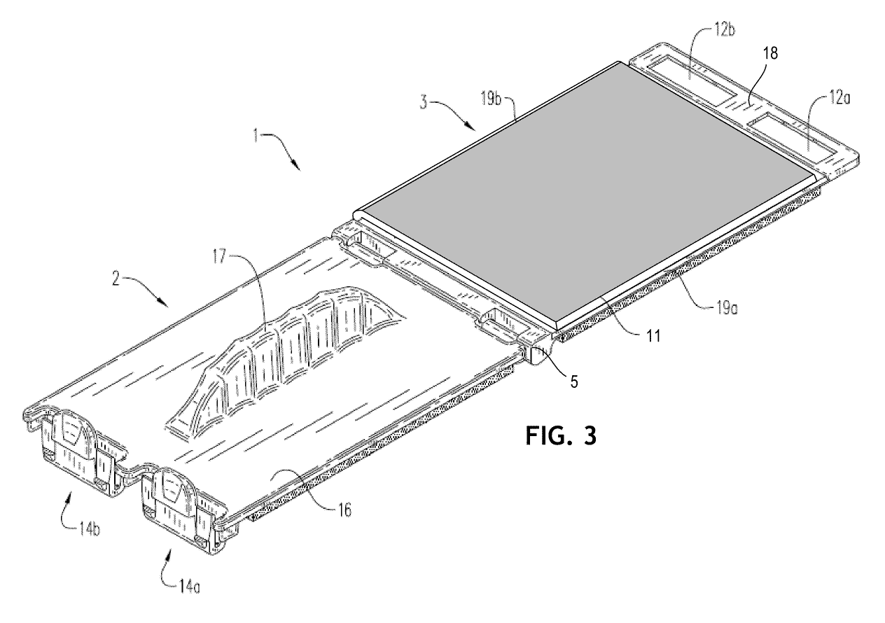

FIG. 3 is a bottom perspective view of apparatus 1 according to some embodiments. First support 2 includes second side 16 to which handle 17 is coupled. Handle 17 may be integral with second side 16 or attached thereto in any manner. In some embodiments, handle 17 may exhibit a size, shape, and/or orientation different from that depicted in FIG. 3.

Second support 3 includes second side 18 to which cleaning material 11 is coupled, and edges 19a and 19b. Edge 19a is beveled to second support 3 between a string and another object located proximate to the string, such as a fretboard, fingerboard or fret. For example, beveled edge 19a may allow second side 18 to “ride” over frets disposed on a neck of a musical instrument. In some embodiments that may be suitable for cleaning guitar strings, second support 3 may be 0.040 in thick and a thinnest portion of beveled edge 19a may be 0.007 in thick. Such an arrangement may allow second support 3 to be placed between a string and an instrument neck (or other structure) even if the string and neck are located particularly close to one another (e.g., at locations close to an instrument “nut”).

Most of edge 19b is covered by a piece of material which includes cleaning materials 9 and 11 as described above. In some embodiments, cleaning material 11 is separate from cleaning material 9 and edge 19b is disposed. Edge 19b may be beveled as described above in such embodiments. According to some embodiments, a piece of material which includes cleaning materials 9 and 11 is wrapped around second support 3 so that both edge 19b and edge 19a are covered as shown in FIG. 13. One or both of edges 19a and 19b may be beveled even if covered by cleaning material.

Second support 3 exhibits a low profile (i.e., small thickness) in some embodiments. This profile facilitates passage of second support 3 between a string and any adjacent structure. As shown in FIG. 3, a portion of second support 3 which defines openings 12a and 12b may be thicker than a portion of support 3 to which material 11 is coupled. Such an arrangement may provide sufficient rigidity around openings 12a and 12b and a sufficiently thin profile for passing between a string and an instrument during cleaning.

The greater thickness of the portion of second support 3 may also serve to provide a lip against which cleaning material 11 may rest to assist the coupling thereof to second side 18. In this regard, a portion of second side 18 adjacent to edge 5 of second support 3 may also be thicker than a portion of support 3 to which material 11 is coupled in order to provide a second lip against which cleaning material 11 may rest.

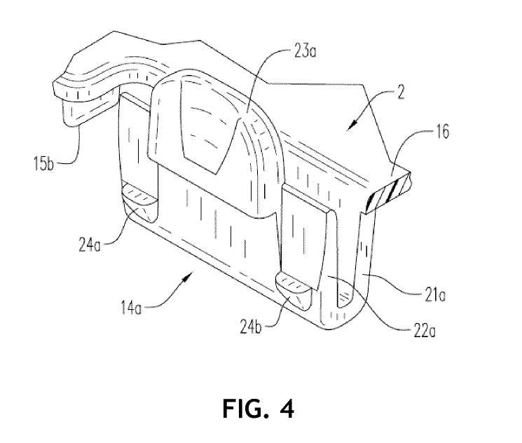

FIG. 4 is a close-up perspective view to describe latch 14a according to some embodiments. Latch 14a of FIG. 4 is integral with first support 2 and includes first leg 21a, second leg 22a, release element 23a, and projections 24a and 24b. Release element 23a extends above second side 16 of support 2. Such a feature may provide efficient separation of latch 14a from corresponding opening 12a in some embodiments.

Projections 24a and 24b may pass through opening 12a and engage second side 18 of second support 3 as will be described below. Projections 24a and 24b may therefore resist movement of first support 2 away from second support 3 and/or assist in maintaining the above-mentioned fixed relationship between first side 8 and second side 10.

Some embodiments allow molding of first support 2, latches 14a and 14b, stops 15a through 15c, and handle 17 as a single integral piece. Second support 3 may also or alternatively be molded as a single integral piece. A thickness and/or composition of second support 3 may differ from a thickness and/or composition of first support 2. For example, a composition of second support 3 may be denser than that of first support 2 to allow for a reduced thickness of support 3 while still providing suitable resistance to twist and skew. The reduced thickness may facilitate passage of second support 3 between a string and an instrument.

In some embodiments, latches 14a and 14b might not be integral with first support 2, and/or the design of latches 14a and 14b may differ from that illustrated and described. A number, design and placement of stops 15a through 15c may differ, as could a number, design and placement of openings 12a and 12b. Embodiments are not limited to the configurations of FIGS. 1 through 4 and the alternatives described herein.

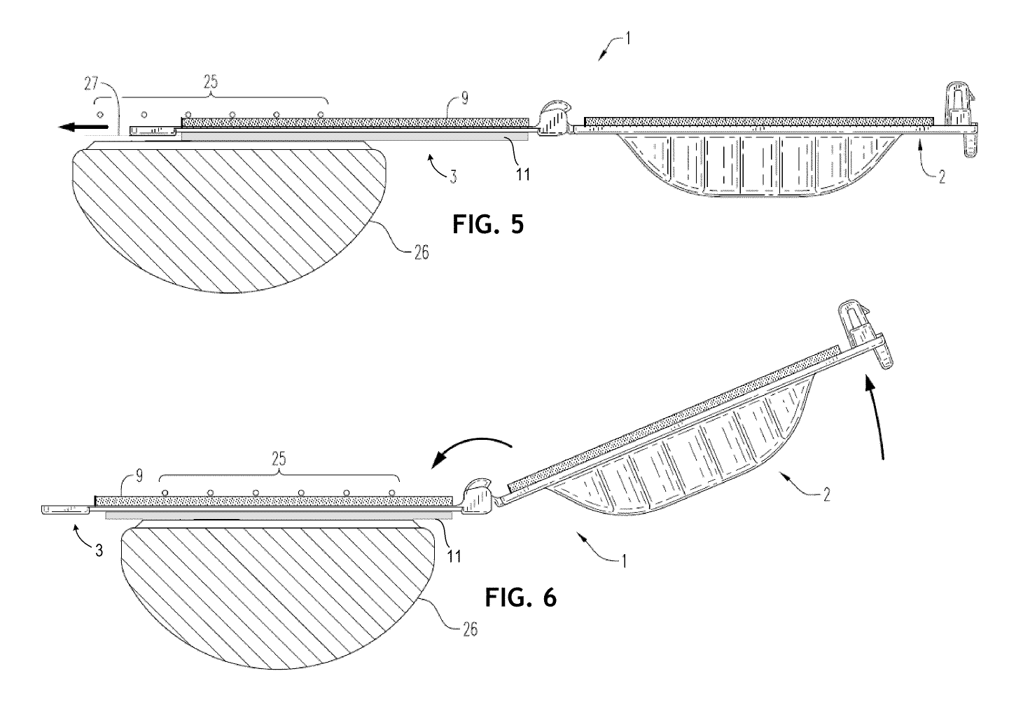

FIGS. 5 through 8 illustrate usage of apparatus 1 according to some embodiments. As shown in FIG. 5, second support 3 may be moved between strings 25 and instrument neck 26 while apparatus 1 is in an “open” position. Strings 25 may comprise any strings to be cleaned according to some embodiments. Strings 25 may comprise a combination of different types of strings (e.g., wound and unwound) having different compositions (e.g., steel and nylon) and different diameters.

Fret 27 is shown coupled to instrument neck 26, but usage is not limited to fretted instruments. A combined thickness of second support 3, cleaning material 9 and cleaning material 11 may be suitable for passage between strings 25 and fret 27. According to some embodiments, a thickness of cleaning material 9 when uncompressed is substantially 0.100 in. and a thickness of support 3 where coupled to cleaning material 9 is substantially 0.040 in.

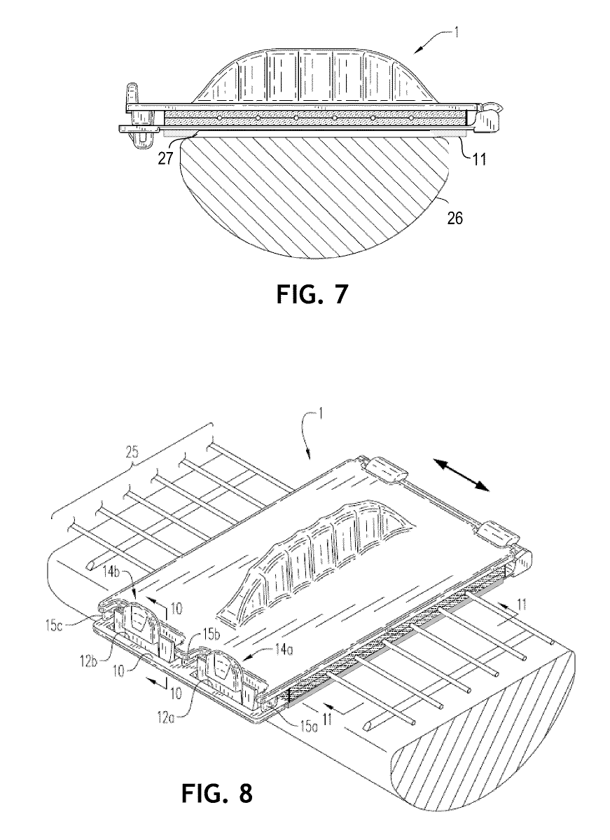

FIG. 6 shows cleaning material 9 disposed between each of strings 25 and second support 3, and cleaning material 11 disposed between second support 3 and instrument neck 26. First support 2 is being rotated in the direction of the illustrated arrows toward second support 3. Although it may be easier to move first support 2 while second support 3 remains substantially stationary, the movement shown in FIG. 7 is relative movement which may include movement of either one or both of the first support 2 and second support 3.

FIGS. 7 and 8 depict apparatus 1 after completion of the movement illustrated in FIG. 6. As shown in FIGS. 7 and 8, cleaning material 7 and cleaning material 9 are in contact with strings 25 and are disposed on substantially opposite sides of strings 25. Moreover, cleaning material 11 is in contact with fret 27 and with instrument neck 26. Latches 14a and 14b engage openings 12a and 12b, and stops 15a through 15c engage first side 10 of second support 3.

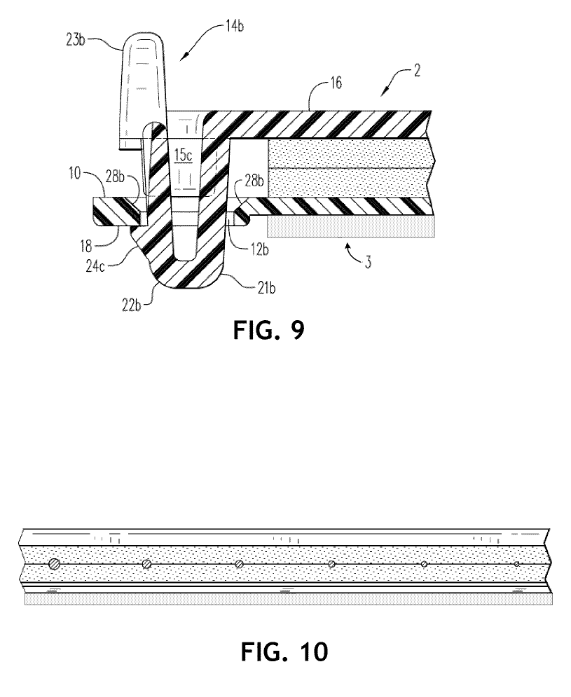

FIG. 9 is a cross-sectional view to illustrate engagement of latch 14b with opening 12b according to some embodiments. Opening 12b is defined by beveled portion 28b of second support 3. As latch 14b enters opening 12b, one or both of legs 21b and 22b may press against and slide across beveled portion 28b. As latch 14b continues through opening 12b, projection 24c also presses against and slides across beveled portion 28. Beveled portion 28b may therefore assist in guiding latch 14b into opening 12b.

Beveled portion 28b may also assist in compressing legs 21b and 22b toward one another. In particular, the engagement of projection 24c with beveled portion 28b as latch 14b passes through opening 12b may bias leg 22b toward leg 21b and allow projection 24c to pass completely through opening 12b. Release element 23b may also or alternatively be manually pressed to bias leg 22b toward leg 21b during passage of projection 24c through opening 12b.

Projection 24c engages second side 18 of second support 3 once projection 24c has passed through opening 12b. FIG. 9 also shows stop 15c engaged with first side 10 of second support 3. Stop 15c (and stops 15a and 15b) may work in conjunction with projections 24a through 24d to resist excessive twisting of first support 2 and second support 3 relative to one another during use. In some embodiments, stop 15c does not contact first side 10 when projection 24c contacts second side 18. Rather, a small gap exists between stop 15c and first side 10 to allow projection 24c to be moved slightly away from second side 18 during engagement and disengagement of latch 14b.

To disengage latch 14b from opening 12b, release element 23b may be pressed to bias leg 22b toward leg 21b until projection 24c disengages from second side 18. In some embodiments, the extension of release element 23b past second side 16 of first support 3 may facilitate access to release element 23b and provide sufficient leverage to disengage projection 24c from second side 18. Support 2 may then be rotated away support 3 to remove latch 14b from opening 12b. Latch 14a may be similarly and simultaneously manipulated to ensure that projections 24a and 24b are also disengaged from second side 18 prior to rotation of first support 2 away from second support 3.

Returning to FIG. 8, apparatus 1 may be moved lengthwise across strings 25. Such motion may allow first cleaning material 7 and second cleaning material 9 to remove debris and fluids from strings 25, and allow third cleaning material 11 to remove debris from one or more of frets 27 and/or the fretboard of neck 26. Third cleaning material 11 may possess any suitable characteristics (e.g., compressibility, conformability, individual cleaning threads of suitable length) which facilitate cleaning of both frets 27 and neck 26 even though these elements are disposed at different relative heights. In some embodiments, materials 7 and 9 include loops which at least partially touch the sides of strings 25 when in the FIG. 9 position and, when moved, “pull” debris from strings 25. Apparatus 1 may be moved perpendicular to the direction of the arrow, and in any direction in between, in order to clean strings 25, frets 27 and/or neck 26.

Cleaning material 7 and/or cleaning material 9 may be compressed to approximately 0.032 in when in the FIG. 10 position. Such compression, in conjunction with a thickness of second support 3, may allow apparatus 1 to clean portions of strings 25 which are located close to instrument neck 26 (e.g., portions adjacent to a “nut” of neck 26).

During movement as shown in FIG. 8, cleaning material 11 may contact a fret 27 and thereby cause upward motion of apparatus 25 which is resisted by strings 25. This phenomenon may provide force for cleaning of portions of strings 25 which face instrument neck 26 with cleaning material 9 and for cleaning the fret 27 and an adjacent portion of neck 26 with cleaning material 11.

A compressive force between first cleaning material 7 and second cleaning material 9 may vary based on distance from latches 14a and 14b according to some embodiments. As illustrated in FIG. 10, such an arrangement may provide an adequate force for cleaning smaller-diameter strings located away from latches 14a and 14b while avoiding the application of too much force on larger-diameter strings located closer to latches 14a and 14b.

The compressive force at each location along apparatus 1 may be controlled in several ways. According to some embodiments, a thickness of one or both of first support 2 and second support 3 may change along the length of apparatus 1 while maintaining the overall height of apparatus 1 when “closed” as shown in FIGS. 7 and 8. In some embodiments, a thickness of one or both of first cleaning material 7 and second cleaning material 9 differs along the length of apparatus 1, while again maintaining the overall height of apparatus 1 as shown in FIGS. 7 and 8.

According to some embodiments, a cleaning agent may be applied to one or more of first cleaning material 7, second cleaning material 9 and third cleaning material 9 prior to engaging latches 14a and 14b with openings 12a and 12b. The cleaning agent applied to first cleaning material 7 and/or second cleaning material 9 may differ from the cleaning agent applied to third cleaning material 11. The cleaning agent applied to first cleaning material 7 and/or second cleaning material 9 may be a liquid and may be particularly suited to cleaning strings of the type to be cleaned. This cleaning agent, as well as a cleaning agent applied to third cleaning material 11, may be non-water-based in order to prevent damage to instrument neck 26. The cleaning agent(s) may be compatible with any adhesive used to couple cleaning materials 7, 9 and 11 to their respective supports.

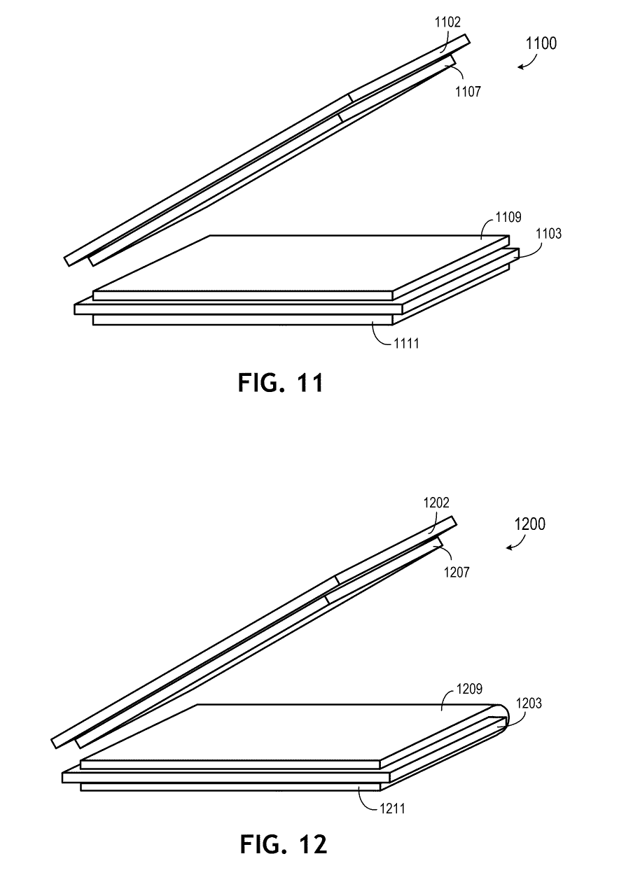

FIGS. 11 through 13 provide representative views of various apparatuses for cleaning musical instruments according to some embodiments. Embodiments may include features in addition to and/or other than those shown in FIGS. 11 through 13.

Apparatus 1100 of FIG. 11 includes first support 1102, second support 1103, cleaning material 1107 coupled to a first side of first support 1102, cleaning material 1109 coupled to a first side of second support 1103, and cleaning material 1111 coupled to a second side of second support 1103. Unlike apparatus 1 described above, cleaning material 1109 and cleaning material 1111 are separate from one another. A coupling between first support 1102 and second support 1103 is unshown to indicate that any coupling may be employed that is or becomes known.

Apparatus 1200 of FIG. 12 includes first support 1202, second support 1203, cleaning material 1207 coupled to a first side of first support 1202, cleaning material 1209 coupled to a first side of second support 1203, and cleaning material 1211 coupled to a second side of second support 1203. Similarly to apparatus 1 described above, cleaning material 1109 and cleaning material 1111 integral with one another, and the single piece of material including cleaning material 1109 and cleaning material 1111 wraps around and over an edge of second support 1203. Again, a coupling between first support 1202 and second support 1203 is unshown to indicate that any coupling may be employed.

Apparatus 1300 of FIG. 13 includes first support 1302, second support 1303, cleaning material 1307 coupled to a first side of first support 1302, cleaning material 1309 coupled to a first side of second support 1303, and cleaning material 1311 coupled to a second side of second support 1303. Cleaning material 1309 and cleaning material 1311 of FIG. 13 may form a contiguous sleeve. Such a sleeve may be efficiently placed over second support 1303 and may advantageously hold itself thereto while it is secured to second support 1303 via a drying adhesive or other fastening system. Alternatively, cleaning material 1309 and cleaning material 1311 of FIG. 13 may be portions of a single piece of material as described with respect to FIG. 12 but which is wrapped around support 1303 so that its opposite ends are touching one another. A coupling between first support 1302 and second support 1303 is unshown to indicate that any coupling may be employed.

Some embodiments may provide one or more of: sufficient cleaning pressure on the strings, cleaning of instrument portions such as frets, fingerboards and fretboards, ease in placing cleaning material between the strings and an instrument, secure maintenance of cleaning material around the strings, resistance to skewing or twisting during use, and ease of disengaging the first support from the second support.

The several embodiments described herein are solely for the purpose of illustration. Embodiments may include any currently or hereafter-known versions of or substitutes for the elements described herein. Therefore, persons in the art will recognize from this description that other embodiments may be practiced with various modifications and alterations.

What is claimed is:

1. An apparatus to clean musical instrument strings, comprising:
a first support;
a first cleaning material coupled to a first side of the first support;
a second support coupled to the first support at a first edge of the second support;
a second cleaning material coupled to a first side of the second support; and
a third cleaning material coupled to a second side of the second support.

2. An apparatus according to claim 1, wherein the second cleaning material is integral with the third cleaning material.

3. An apparatus according to claim 2, wherein the second cleaning material and the third cleaning material form a contiguous sleeve.

4. An apparatus according to claim 1, wherein the second support comprises:
a third beveled edge and a fourth beveled edge opposite the third beveled edge,

5. An apparatus according to claim 1, wherein the second support is denser than the first support.

6. An apparatus according to claim 1, wherein the second support comprises anti-skew ribs.

7. A method comprising:
placing a second support between a musical instrument and a string coupled to the musical instrument;
rotating a first support coupled to a first edge of the second support with respect to the second support to dispose the string between the first support and the second support, to bring a first cleaning material coupled to a first side of the first support in contact with the string, to bring a second cleaning material coupled to a first side of the second support in contact with the string, and to bring a third cleaning material coupled to a second side of the second support in contact with the musical instrument.
